(19) United States
(12) Patent Application Publication
(10) Pub. No.: US 2005/0081206 A1
(43) Pub. Date: Apr. 14, 2005

(54) Methods and apparatus for profiling threaded programs

(76) Inventors: Douglas R. Armstrong, Champaign, IL (US); Anthony D. Nguyen, Mountain View, CA (US); Paul M. Petersen, Champaign, IL (US); Sanjiv M. Shah, Champaign, IL (US)

Correspondence Address: GROSSMAN & FLIGHT LLC, Suite 4220, 20 North Wacker Drive, Chicago, IL, 60606-6357, US

(21) Appl. No.: 10/684,662

(22) Filed: Oct. 14, 2003

(51) Int. Cl. G06F 9/46

(52) U.S. Cl. 718/100

(57) ABSTRACT

A method and apparatus for profiling threaded programs is disclosed. The method may include monitoring information exchanged between a processing unit and first and second threads executed by the processing unit, determining a critical path of thread execution and determining a wait time during which the first thread awaits a synchronization event. The method may also include determining whether the wait time affects the critical path of thread execution and indicating that the wait time is of a high priority if the wait time affects the critical path of thread execution, and indicating that the wait time is of a low priority if the wait time does not affect the critical path of thread execution.

### TECHNICAL FIELD

The present disclosure pertains to computer program execution and, more particularly, to methods and apparatus for profiling threaded programs.

### BACKGROUND

Commonly, computer software programs are composed of numerous portions of instructions that may be executed. These portions of instructions are referred to as threads and a program having more than one thread is referred to as a multithreaded program. Thread execution of the threads is coordinated by an operating system (OS) scheduler, which determines the execution order of the threads based on a number of available processing units to which the OS scheduler has access.

As will be readily appreciated, different threads may execute at different intervals based on an established priority. For example, a personal computer may run various threads, one of which may control mouse operation and one that may control disk drive operation. In user interface situations including calculations and data manipulation, which encompasses nearly all user interface situations, it is essential that the user feel that he or she is always in control of the machine via the mouse. Accordingly, the OS scheduler ensures that threads responsible for mouse operation (e.g., the mouse driver) execute more frequently than threads for writing information to a computer hard drive. Scheduling enables a user to retain mouse control while information is being written to the hard drive.

Multithreaded programs may be executed on a single processor that executes one thread at a time, but duty cycles between multiple threads to advance the execution of each thread. Alternatively, some processors are capable of simultaneously executing multiple threads. Additionally, a number of processors may be networked together and may be used to execute the various threads of a multithreaded program.

While a thread is performing calculations on its private data, that thread has no significant impact on the execution of other threads, unless the system is oversubscribed, meaning that there are more threads to be run than resources to run the threads. However, when threads need to interact directly, through the exchange of data, or indirectly, through the need for a common resource, the performance of the threads themselves is affected, as well as the execution of the overall software formed by the threads. Requests for system services (such as thread creation, synchronization and signaling) have a significant effect on thread behavior and interaction. For example, if a first thread is waiting for a second thread to release a resource, it is possible that the wait time of the first thread directly contributes to the overall execution time of the software application of which the threads are a part.

As will be readily appreciated by those having ordinary skill in the art, multithreaded software is written to execute in an expedient manner. Accordingly, threaded software must be carefully designed and implemented to ensure rapid overall program execution. Inevitably during threaded program design and implementation, the threaded program does not execute as fast as desired, due to bottlenecks in the threading of the program structure.

Multithreaded program developers typically use profilers for determining where bottlenecks exist in multithreaded programs. Conventional profilers, such as the CallGraph functionality of the VTune Performance Environment or the Quantify product available from Rational, report a wait time value indicating the period of time during program execution that each thread spent waiting for synchronization. Developers using these conventional profilers seek to minimize the overall wait of each thread and to, thereby, reduce the overall execution time of a multithreaded program.

### BRIEF DESCRIPTION OF THE DRAWINGS

FIG. 1 is a diagram of an example computer system.

FIG. 2 is a functional diagram showing detail of the example multiprocessor of FIG. 1.

FIG. 3 is a diagram showing example execution times of the example threads of FIG. 2.

FIG. 4 is a diagram showing detail of the example performance monitor of FIG. 2.

FIG. 5 is a flow diagram of an example critical path generation process.

FIG. 6 is a pseudocode listing describing an example fork event process of FIG. 5.

FIG. 7 is a flow diagram showing detail of an example fork event process of FIG. 5.

FIG. 8 is a diagram illustrating example processing of a critical path tree corresponding to the example fork event processes of FIGS. 5 and 6.

FIG. 9 is a pseudocode listing describing an example entry event process of FIG. 5.

FIG. 10 is a flow diagram showing detail of an example entry event process of FIG. 5.

FIG. 11 is a diagram illustrating example processing of a critical path tree corresponding to the example entry event processes of FIGS. 9 and 10.

FIG. 12 is a pseudocode listing describing an example signal event process of FIG. 5.

FIGS. 13A and 13B form a flow diagram showing detail of an example signal event process of FIG. 5.

FIG. 14 is a diagram illustrating example processing of a critical path tree corresponding to the example signal event processes of FIGS. 12, 13A and 13B.

FIG. 15 is a pseudocode listing describing an example wait event process of FIG. 5.

FIGS. 16A and 16B form a flow diagram showing detail of an example wait event process of FIG. 5.

FIG. 17 is a diagram illustrating example processing of a critical path tree corresponding to the example wait event process of FIGS. 15, 16A and 16B.

FIG. 18 is a pseudocode listing describing an example suspend event process of FIG. 5.

FIG. 19 is a pseudocode listing describing an example resume event process of FIG. 5.

FIG. 20 is a diagram illustrating example processing of a critical path tree corresponding to the example resume event process of FIG. 19.

FIG. 21 is a pseudocode listing describing an example block event process of FIG. 5.

FIG. 22 is a diagram illustrating example processing of a critical path tree corresponding to the example block event process of FIG. 21.

### DETAILED DESCRIPTION

Although the following discloses example systems including, among other components, software executed on hardware, it should be noted that such systems are merely illustrative and should not be considered as limiting. For example, it is contemplated that any or all of these hardware and software components could be embodied exclusively in dedicated hardware, exclusively in software, exclusively in firmware or in some combination of hardware, firmware and/or software. Accordingly, while the following describes example systems, persons of ordinary skill in the art will readily appreciate that the examples are not the only way to implement such systems.

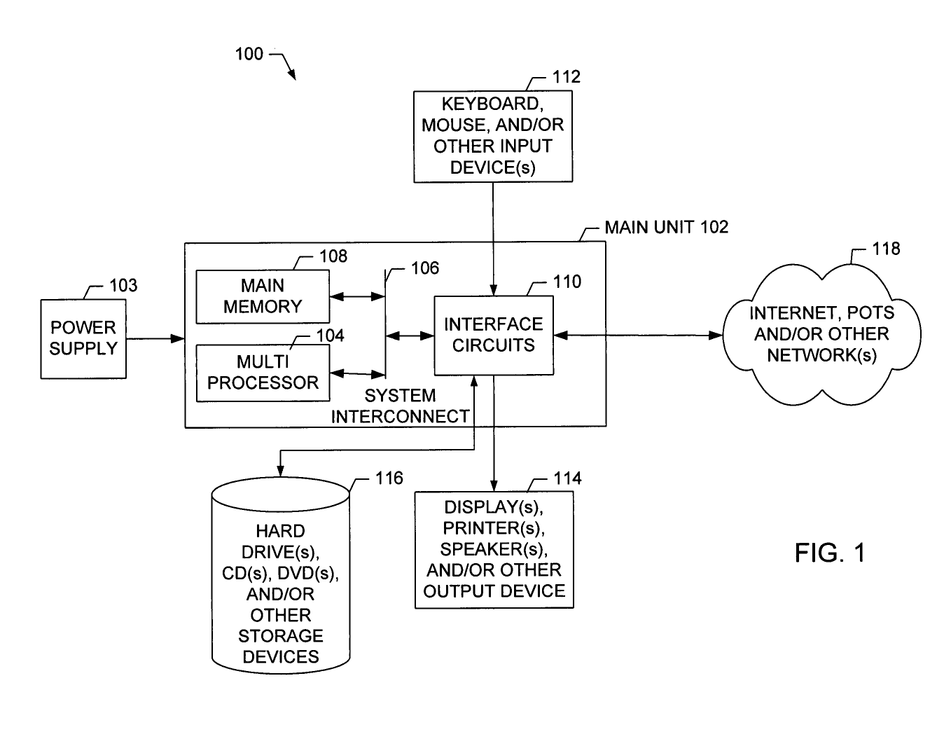

As shown in FIG. 1, a computer system 100 includes a main processing unit 102 powered by a power supply 103. By way of example and not limitation, the computer system 100 may be a personal computer (PC), a personal digital assistant (PDA), an Internet appliance, a cellular telephone, or any other computing device. In the example, the main processing unit 102 includes a multiprocessor unit 104 electrically coupled by a system interconnect 106 to a main memory device 108 and one or more interface circuits 110. The system interconnect 106 is an address/data bus. Of course, a person of ordinary skill in the art will readily appreciate that interconnects other than busses may be used to connect the multi-processor unit 104 to the main memory device 108. For example, one or more dedicated lines and/or a crossbar may be used to connect the multiprocessor unit 104 to the main memory device 108.

The multiprocessor 104 may include any type of well-known processing unit, such as a microprocessor from the Intel Pentium® family of microprocessors, the Intel® Itanium® family of microprocessors, and/or the Intel XScale® family of processors. The multiprocessor 104 may include any type of well-known cache memory, such as static random access memory (SRAM). The main memory device 108 may include dynamic random access memory (DRAM), but may also include non-volatile memory. In one example, the main memory device 108 stores a software program that is executed by one or more processing agents, such as, for example, the multiprocessor unit 104.

The interface circuit(s) 110 may be implemented using any type of well-known interface standard, such as an Ethernet interface and/or a Universal Serial Bus (USB) interface. One or more input devices 112 may be connected to the interface circuits 110 for entering data and commands into the main processing unit 102. For example, an input device 112 may be a keyboard, mouse, touch screen, track pad, track ball, isopoint, and/or a voice recognition system.

One or more displays, printers, speakers, and/or other output devices 114 may also be connected to the main processing unit 102 via one or more of the interface circuits 110. The display 114 may be cathode ray tube (CRTs), liquid crystal displays (LCDs), or any other type of display. The display 114 may generate visual indications of data generated during operation of the main processing unit 102. The visual displays may include prompts for human operator input, calculated values, detected data, etc.

The computer system 100 may also include one or more storage devices 116. For example, the computer system 100 may include one or more hard drives, a compact disk (CD) drive, a digital versatile disk drive (DVD), and/or other computer media input/output (I/O) devices.

The computer system 100 may also exchange data with other devices via a connection to a network 118. The network connection may be any type of network connection, such as an Ethernet connection, digital subscriber line (DSL), telephone line, coaxial cable, etc. The network 118 may be any type of network, such as the Internet, a telephone network, a cable network, and/or a wireless network.

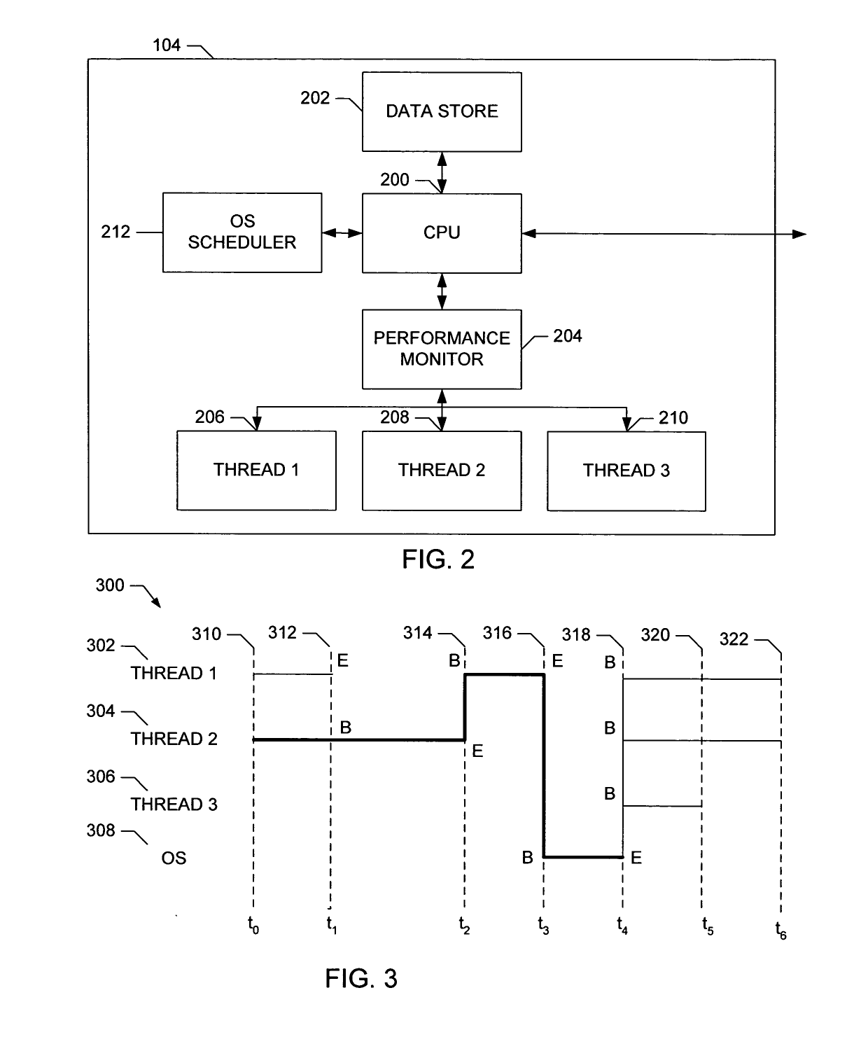

As shown in FIG. 2, the multiprocessor 104 includes at least one processing unit 200 having an associated data store 202. In the example shown, the processing unit 200 cycles its execution resources in conjunction with a performance monitor 204, between three threads 206-210 of a multithreaded program. As described below in detail, the performance monitor 204 selectively observes or modifies information passed between the processing unit 200 and the threads 206-210. The manner in which the processing unit 200 services the threads 206-210 is dictated by an OS scheduler 212, which, for example, may include thread priorities that control how the processing unit 200 dedicates its resources. As will be readily appreciated by those having ordinary skill in the art, each of the threads 206-210 makes requests to the processing unit 200 for various services, including resource allocation, thread synchronization and the like, but, as shown in FIG. 2, the requests for service are routed through the performance monitor 204.

The performance monitor 204 is interposed between each of the threads 206-210 and the processing unit 200. As described in detail below, the performance monitor 204 observes communications taking place between the threads 206-210 and the processing unit 200 and compiles statistics pertinent to thread execution performance. Additionally, the performance monitor 204 may selectively intercept and modify communications between the processing unit 200 and the threads 206-210 when such communications pertain to thread intersection, creation or other activities that are germane to the timing and execution of the threads 206-210. In particular, the performance monitor 204 determines the critical path of program execution and the portions of each thread's lifetime that define the critical path for execution of the entire multithreaded program consisting of the threads 206-210. The disclosed methods and apparatus separate wait time caused by synchronization activities into a high priority category, which has an impact on the execution time of the program, and a low priority category in which the wait time has overlapped with a useful event, such as a computation. For example, objects or activities falling on the critical path of program execution may be characterized as high priority because such objects or activities directly affect the time it takes a program to complete execution. One way in which wait times may be categorized as high priority is when objects or activities depend on one another. The high priority category enables the system to guarantee to the user that improving the performance of the parts of the software that are in the high priority category will result in improved software execution speed. The performance monitor 204 also determines the impact of thread synchronization or signaling operations for threads that are dependent on a thread that is part of the critical path of program execution.

The critical path of program execution is defined as the continuous flow of execution from start to end that does not count the time program threads spend waiting for events external to the program (e.g., operating system delays). For example, if an executing thread is interrupted by a wait for a lock from a particular resource, that thread is no longer on the critical path unless that wait times out. As a further example, in the case of a thread releasing a lock, when the thread signals and releases a lock, program flow branches off, leaving the possibility that the critical path continues along the thread that signaled or the possibility that the critical path is transferred to a thread that received the signal. This methodology enables possible critical paths either to be killed or split into several possibilities. At the end of the threaded program execution when there is only a single thread remaining, the performance monitor 204 resolves the one critical path for program execution. If the execution of the performance monitor 204 is halted before threaded program execution completes, there may be several active threads and thus, several possible critical paths.

An example execution timing diagram 300 of a multithreaded program having three threads is shown in FIG. 3. The timing diagram includes a y-axis entry for each thread, denoted with reference numerals 302-306, and also includes a y-axis entry for the OS 308. The x-axis of FIG. 3 is broken into a number of time ranges t₀-t₆, which are represented by vertical lines 310-322. The following description is provided with respect to the execution of the multithreaded program of having three threads 206-210, as shown in FIG. 2. It is the critical path, such as the critical path shown and described in conjunction with FIG. 3, that the performance monitor 204 produces.

The execution timing diagram 300 is a collection of disjoint spans, each span being associated with a particular thread, a particular synchronization object that causes the transition to a different thread in the following span and the source locations in the software that caused the transition in the software execution. As described below, spans representing the foregoing data are summarized to reduce the amount of data needed to be stored to determine the critical path of the software. The entire timeline is broken into spans, but, to conserve data storage requirements, the spans are merged to hold information about the non-contiguous portions of time.

The timing diagram 300 shows the interdependencies of the various threads. For example, between time t₀ and time t₁, both thread 1 and thread 2 (206 and 208) are executing. At time t₁, thread 1 (206) ends, or pauses, its execution and thread 2 (208) continues to execute until time t₂. The execution of thread 1 (206) is dependent on a synchronization event with thread 2 (208), so thread 1 (206) resumes execution at t₂, when thread 2 (208) stops execution. For example, thread 1 (206) may be awaiting a resource that thread 2 (208) is using, or may be awaiting information that thread 2 (208) is processing. Thread 1 (206) continues execution until t₃, at which point in time the OS (e.g., scheduler 212 of FIG. 2) uses the processing unit 200, exclusively between t₃ and t₄. At t₄, each of the threads 206-210 begins execution, but the critical path cannot yet be determined, because events occurring in time past t₆ determine the critical path at t₄ and following time frames.

In the timing diagram 300 of FIG. 3, the critical path of execution is shown as a bolded line. The critical path is determined based on the interaction between threads to be executed. For example, the execution of thread 1 (206) between t₀ and tᵢ cannot be on the critical path because thread 1 (206) must wait for thread 2 (208) to complete its execution before thread 1 (206) can resume execution.

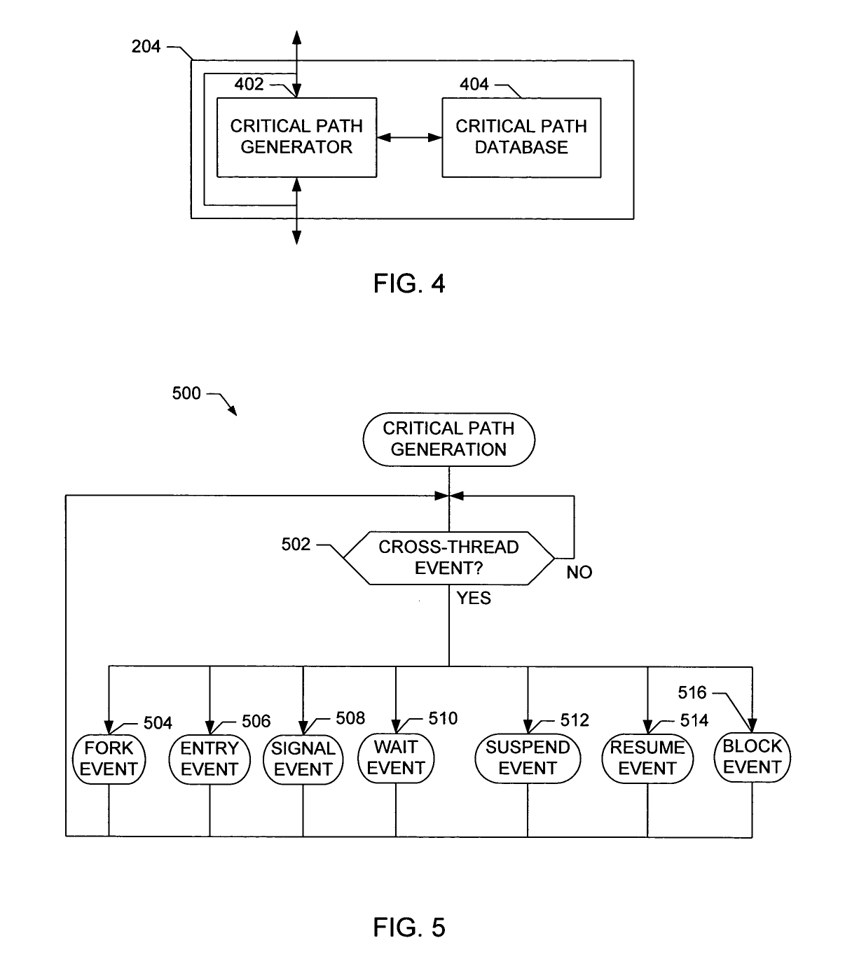

As shown in FIG. 4, the performance monitor 204 of FIG. 2, in one example, includes a critical path generator 402 and a critical path database 404, as shown in FIG. 4. During operation of the multiprocessor 104, the performance monitor 204 and, in particular, the critical path generator 402, observes the communications that take place between the threads 206-210 and the processing unit 200. The communication between the threads 206-210 and the processing unit 200 includes timestamps, requests for resources and synchronization and other low level information. The critical path generator 402 derives performance information from the low level timestamps gathered during execution of the threads 206-210 and uses the information to maintain a critical path tree in a critical path database 404.

As described below, nodes of the critical path tree in the critical path database 404 hold information not only about the threads they represent, but also hold information pertinent to synchronization objects that caused transitions or possible transitions in the critical path, timing information, flat profile information, the number of active threads and the source code location information regarding from where the synchronization events were initiated. Flat profiling information can be used to serially optimize the critical path of the program, which will directly affect the total execution time of the program. The information stored in each node of the critical path possibility tree may be represented by a span of information including information representative of the object that caused the critical path transition, as well as the source code locations that caused the beginning and end of a transition and the source location of a new thread. A span may be represented as shown in Equation 1.
Span=(R, OBJ, SL_{begin}, SL_{end}, SLₚᵣₑᵥ, SLₙₑₓₜ) Equation 1
In Equation 1, R represents which recording is taking place, OBJ is the object that caused the critical path transition, SL_{begin} represents a beginning of the source code location that caused the critical path transition, SL_{end} represents an end of the source code location that caused the critical path transition, SLₚᵣₑᵥ represents the location of the source code that was previously on the critical path, and SLₙₑₓₜ represents the location of the next source code that is on the critical path as a result of the critical path transition.

As shown in Table 1 below, for parallel/synchronization optimizations, the span contains timing vectors that hold overhead time, cruise time, blocking time, and impact time for each thread. An impact time reduction has a direct relationship to reducing total execution time of the software.

The data stored in each span is stored on a per-concurrency-level basis, wherein a concurrency level is defined as the number of threads that are active or run-queued at a particular point in time. For example, if a multithreaded program included three threads, one of which was being executed and two of which were waiting, the concurrency level would be one. The data stored within each span for a single concurrency level may be represented by Table 1 below. Although Table 1 is shown as a single two-dimensional table, in reality a complete version of Table 1 is maintained for each concurrency level. Conceptually, this may be envisioned as a number of versions of Table 1 stacked to form a three-dimensional arrangement of information.

TABLE 1

| | | | |
|---|---|---|---|
| Thread | Prof_{C,} | <T_{C,} T_{I}, T_{O}, T_{B}> | HPM_{C} |

T₀
. . .
Tₙ

In Table 1, Tᵢ represents thread i, where i is a thread number represented in the left-most column of Table 1, CL represents the concurrency level, and the subscript C denotes critical path information. All of the following parameters are defined on a per concurrency level basis. Accordingly, Prof_{C,i,CL} represents the profile data along the critical path for thread i for a concurrency level CL. Additionally, T_{C,i,CL} is the time that thread i was on the critical path for a concurrency level CL, Ti_{I,i,CL} is the impact time of thread i (which is the time thread i spent waiting for a thread on the critical path) for concurrency level CL, T_{O,i,CL} is the overhead time of thread i (which is the time spent by the operating system to provide synchronization services to thread i or the time thread i spends in the run-queue) for concurrency level CL, and T_{B,i,CL} is the blocking/idle time that thread i spent waiting for the occurrence of an external event for concurrency level CL. HPM_{C,i,CL} represents the hardware performance data monitor along the critical path for thread i for concurrency level CL.

The concurrency level may be compared to the number of processors in a system to, for example, determine if the system is fully utilized. For example, if the concurrency level is less than the number of available processors, the system is being under-utilized. By improving processor utilization, during the time that the next thread on the critical path is waiting for the current thread on the critical path, the concurrency of the software may be increased and the overall run-time of the software may be reduced.

Further details on the operation of the critical path generator 402 and the critical path database 404 that it maintains are provided below. A critical path generation process, shown at reference numeral 500 of FIG. 5 examines the low-level time stamps and other communications (e.g., requests for synchronization or resources) passed between the processing unit 200 and the threads it executes (e.g., the threads 206-210) and watches such information to determine if a cross-thread event (e.g., a fork event, an entry event, a signal event, a wait event, etc.) has occurred (block 502). The critical path generation process 500 generates and maintains a critical path possibility tree including, at any point in the multithreaded program execution, leaf nodes representing an active (i.e., a running or run-queued) thread. Cross-thread events are significant because, as described below, cross-thread events are events that affect the critical path possibility tree generated and maintained by the critical path generation process 500. As described below, based on cross-thread events, leaf nodes are added to or pruned from the critical path possibility tree. For example, when an attempt to acquire a synchronization object by a first thread results in a wait because a second thread holds the desired object, the leaf node of the critical path possibility tree representing the first thread is removed from the tree because the first thread cannot possibly be on the critical path. Alternatively, for example, when a first thread releases a synchronization object for which a second thread is waiting, the second thread restarts execution and a new leaf representing the second thread is added to the critical path possibility tree because the second thread is now active. More particularly, as described below, a fork or signal event potentially creates one or more new leaves in a critical path tree. In contrast, a wait event potentially removes a leaf from the critical path tree.

The critical path generation process 500 waits for a cross-thread event (block 502). In general, when the critical path generation process 500 observes a cross-thread event, it identifies the type of the cross-thread event and carries out one of a fork event process 504, an entry event process 506, a signal event process 508, a wait event process 510, a suspend event 512, a resume event 514 or a block event 516 to maintain the critical path possibility tree in a current condition that reflects the effects of the cross-thread event. As will be readily appreciated by those having ordinary skill in the art, while the example of FIG. 5 enumerates a number of example cross-thread events, numerous other cross-thread events could be detected and processed by the critical path generation process 500, provided processes to handle such cross-thread events were included in the critical path generation process 500.

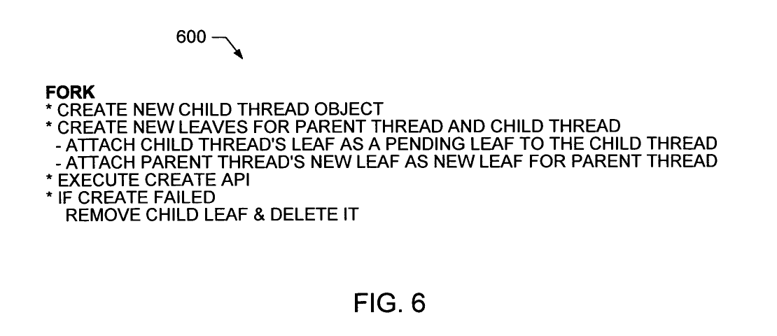

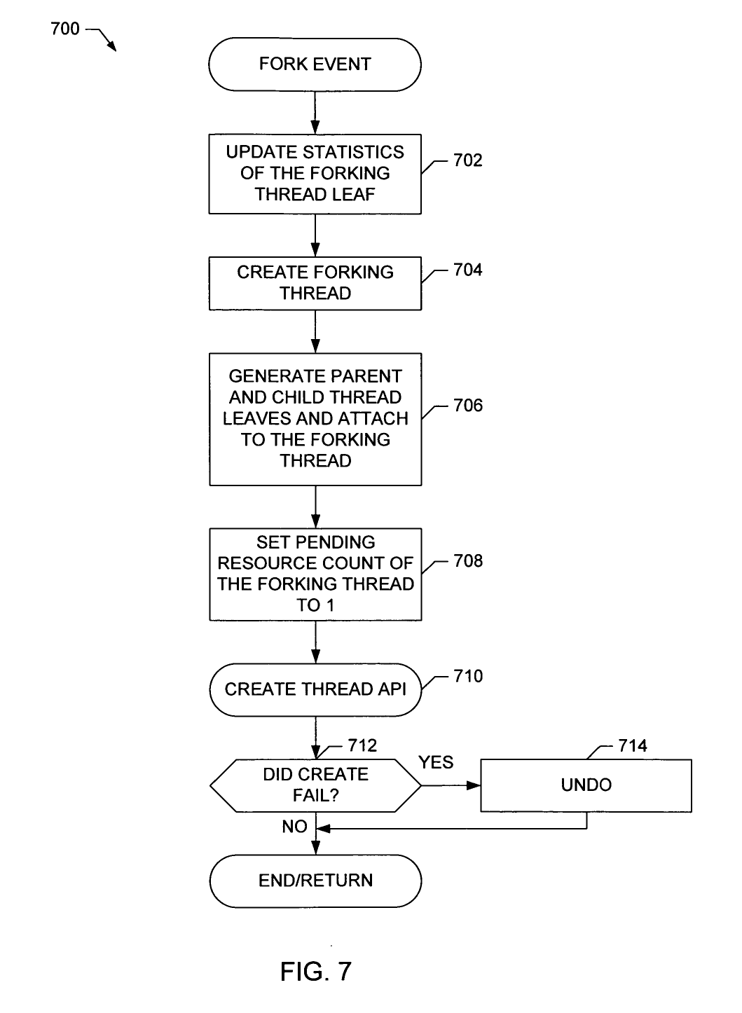

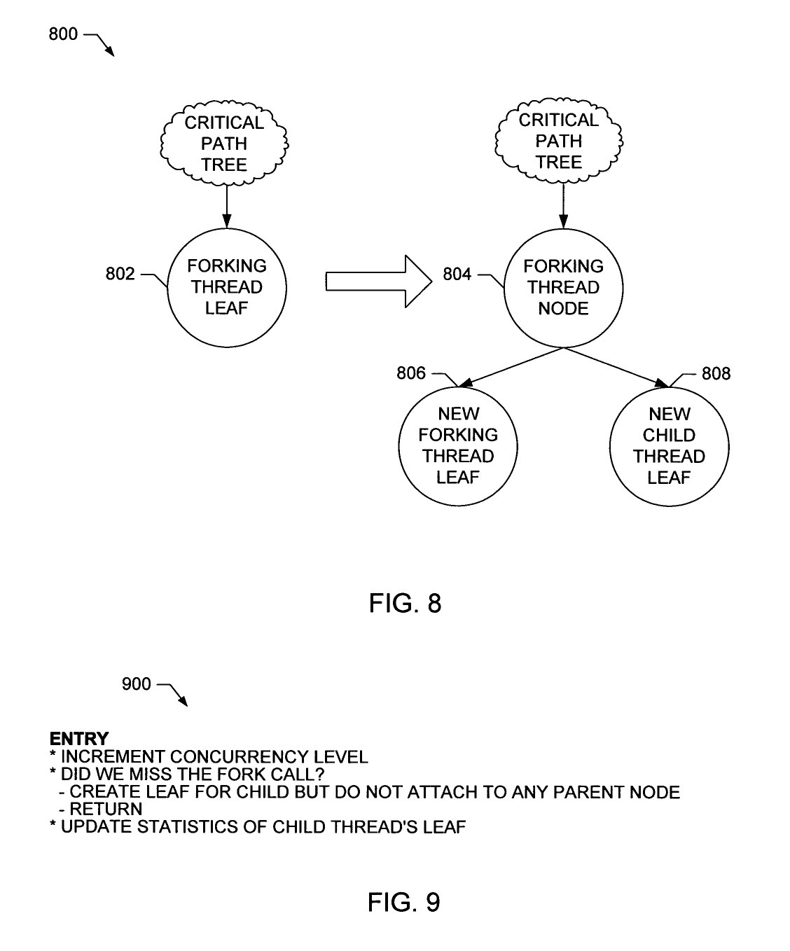

If the detected cross-thread event is a fork event, the fork event process (block 504) is carried out. As will be readily appreciated by those having ordinary skill in the art, fork events correspond to invocations of the CreateThread Application Program Interface (API) in Windows® and pthread_create in Unix/Portable Operating System Interface (POSIX). Detail pertinent to the fork event process (block 504) is provided below in conjunction with a fork event process 600 described in conjunction with the pseudocode of FIG. 6 and a fork event process 700 described using a flow chart in FIG. 7. The resulting effects of the fork event on an example possible critical path tree are described in conjunction with FIG. 8.

Referring to FIG. 6, the fork event process 600 begins by creating a new child thread object and creating new leaves for the parent thread and the child thread. The leaf representing the child thread is attached as a pending leaf to the child thread and the leaf representing the parent thread is attached as a new leaf for the parent thread. After the leaves have been created and attached to the critical path tree, a create API is called to generate a new thread. If the create fails, the child leaf is removed and deleted.

A flow diagram of an example fork event process 700, as shown in FIG. 7, will now be described with reference to FIG. 8. As shown in FIG. 8, a critical path possibility tree, shown generally at reference numeral 800 includes a forking thread leaf 802. As shown in the example of FIG. 7, upon receiving an indication of a fork event, the fork event process 700 updates the statistics of the forking thread leaf 802 (block 702) and creates a forking thread node 804 of FIG. 8 (block 704). After the forking thread node 804 is created (block 704), new parent and child thread leaves (806 and 808 of FIG. 8) are generated and attached to the forking thread leaf 804 (block 706). The pending resource count of the forking threaded node 804 is set to one (block 708) and a create thread API is then called and executed (block 710). The operating of calling the create thread API is an OS call.

If the thread creation failed (block 712), the processing described in conjunction with blocks 702-708 is undone (block 714). Accordingly, the child leaf 808 is removed from the forking thread node 804. Alternatively, if the thread creation did not fail (block 712), the fork event process ends or returns control to the critical path generation process 500 of FIG. 5.

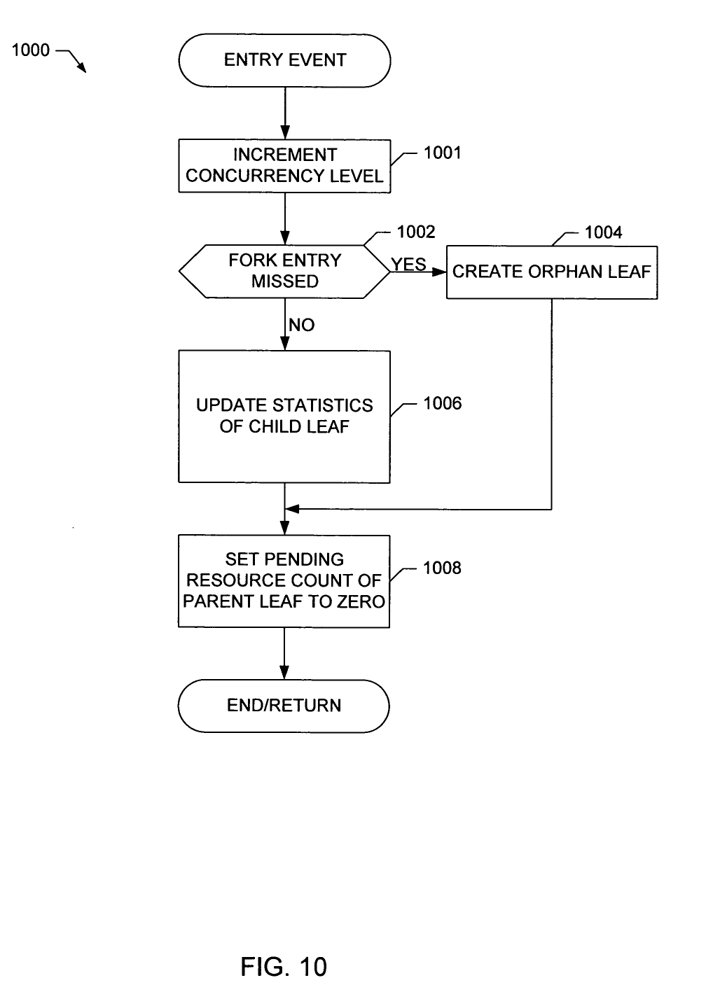

Returning briefly to FIG. 5, if the cross-thread event is an entry event (i.e., the beginning of the execution of a thread), the entry event process is carried out. Pseudocode and flow diagram representations of example entry event processes are shown in FIGS. 9 and 10, respectively.

With reference to an entry event process 900 of FIG. 9, the entry event process determines if a fork call was missed and, if so, a child leaf is created, but is not attached to any parent node. After the child leaf is created, the entry process completes. Conversely, if a fork call was not missed, the concurrency level is updated and the statistics of the child thread's leaf are incremented.

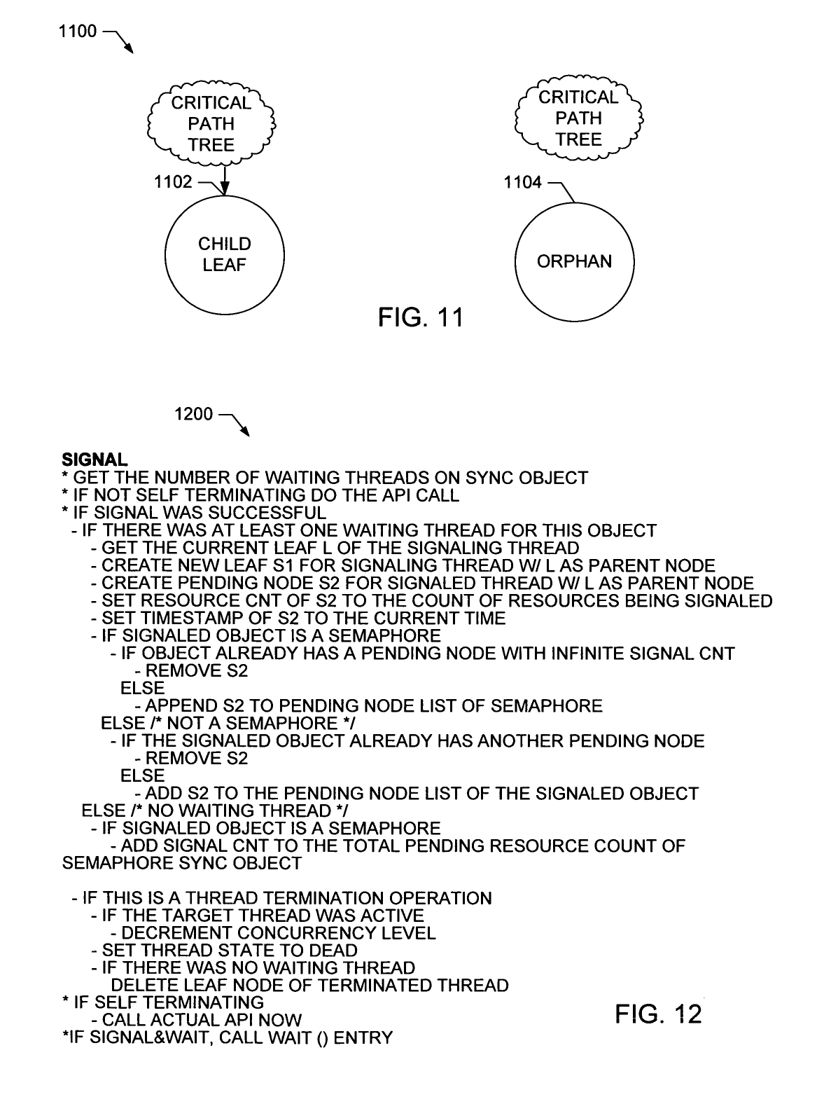

The example entry event process 1000, as shown in detail in FIG. 10, begins by incrementing the concurrency level of the system (block 1001) and by determining if a fork event was missed (block 1002) in a critical path possibility tree 1100 of FIG. 11. If the fork entry was missed, an orphan leaf is created as shown at 1104 of FIG. 11 (block 1004). The determination that a fork event was missed is based on the fact that the thread to be entered (i.e., have its execution started) is not found in the critical path possibility tree 1100. The thread is to be entered, so it must have been created by a fork event, but the performance monitor 204 of FIG. 2 did not perceive the events that created the orphan and, therefore, did not create a leaf corresponding to the new thread.

Conversely, if it is determined that the fork entry was not missed (block 1002) (i.e., the thread to be entered is found in the critical path tree as a child leaf 1102), the entry event process 1000 updates the statistics of the child leaf 1102 (block 1006). After the statistics of the child leaf 1102 are updated (block 1006), the event entry process 1000 sets the pending resource count of the parent leaf to zero (block 1008) and returns control to the critical path generation process 500 of FIG. 5.

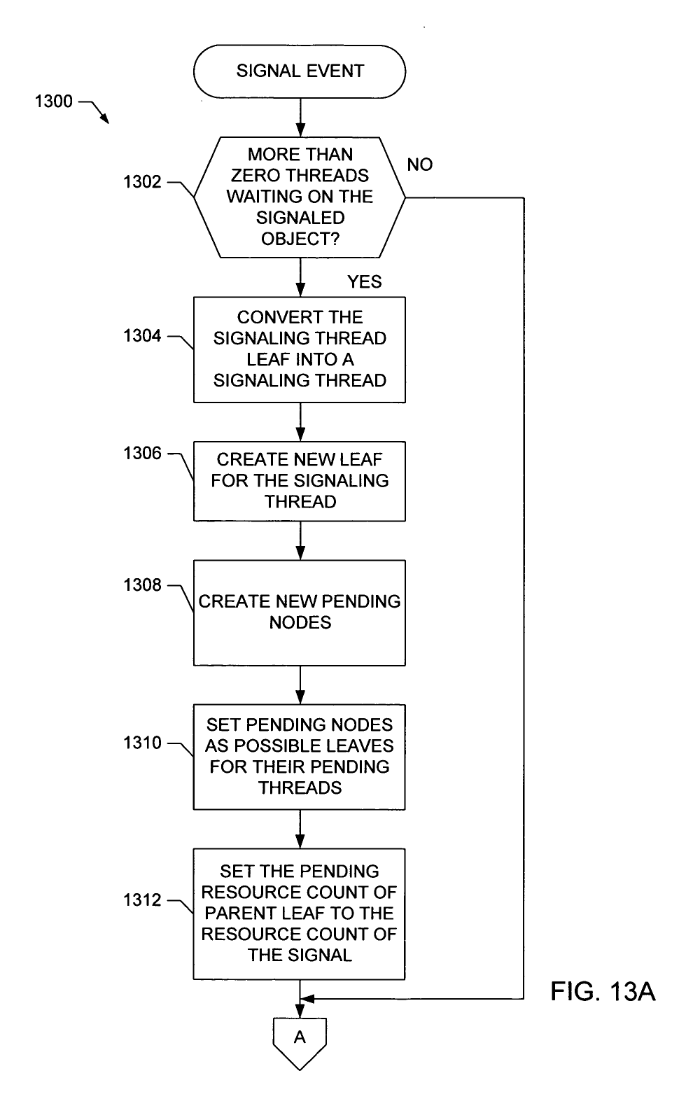

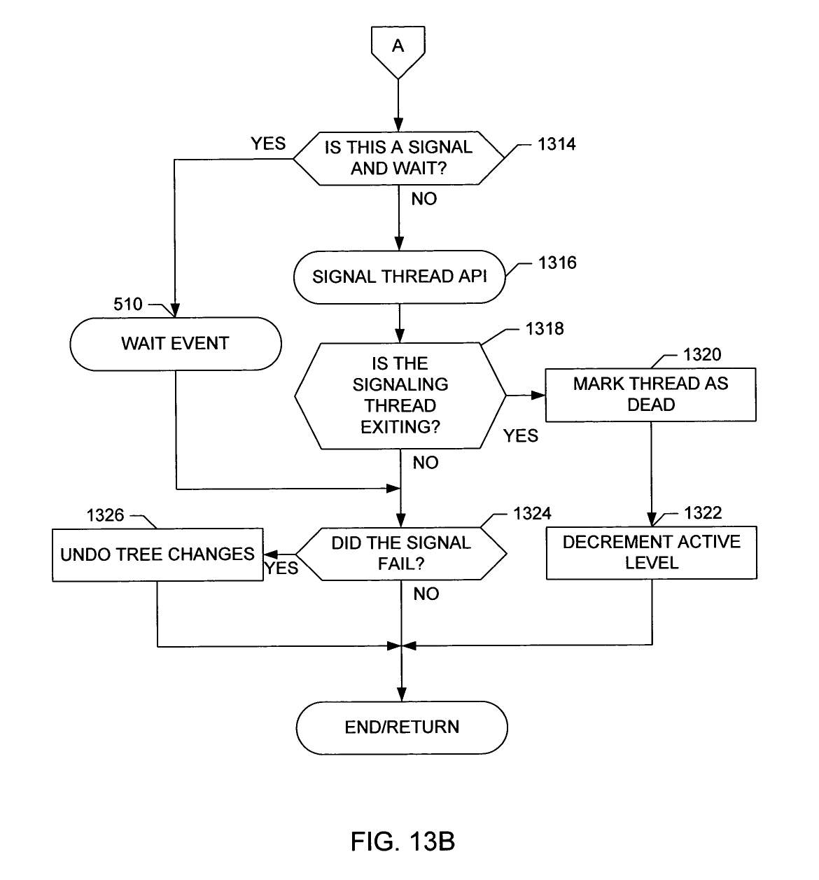

If the critical path generation process 500 of FIG. 5 determines that the cross-thread event is a signal event, a signal event process 508 is carried out. Example signal event processes are shown in FIGS. 12 and 13. As will be readily appreciated by those having ordinary skill in the art, a signal event transpires when a thread releases one or more resources. For example, signaling may include thread exits, LeaveCriticalSection, PulseEvent, SetEvent, ReleaseMutex, ReleaseSemophore and SignalAndWait scenarios. The number of resources being released by a particular thread is referred to as the resource count of the signal.

Turning to the pseudocode shown in FIG. 12, the number of threads waiting on the synchronization object that is being signaled is determined. As long as the API is not a self-termination, which would cause the current thread to terminate, or a signal and wait, it passes control to the OS to perform the actual signaling API. If the signal was successful and there is at least one thread waiting for that synchronization object then it will update the system as follows:

Determine the current leaf for the signaling thread and create a new leaf for the signaling thread with the old leaf as its parent node.

Create a new pending leaf node for the synchronization object with its signal count set to that of the resource count signaled in the API and the timestamp of the signal set to the current time.

If the sync object is a semaphore (i.e., it supports multiple resource count signaling) then it will add the new pending node to its list unless a previous node already has an infinite signal count, in which case the newly created pending node is not used. If the sync object does not support multiple resource count signaling, the new pending node is set as the synchronization object's pending node unless it is already has a pending node, in which case the newly created pending node is unused.

If there is no other thread waiting for this synchronization object, but it is a semaphore, then the object's pending resource count is incremented by the number of resource counts signaled.

If this was a thread termination operation then the following extra steps are taken:

If the target thread was active at the time then the concurrency level is decremented and the target thread's state is set to dead.

If there is no other thread waiting for the target thread's death (i.e., a join operation) then the target thread's leaf is destroyed.

If the API was a self-termination API then the OS is now called to destroy the current thread.

If the API was a signal and wait operation, then the WAIT part of the library is called. It is within this block that the actual OS API is called.

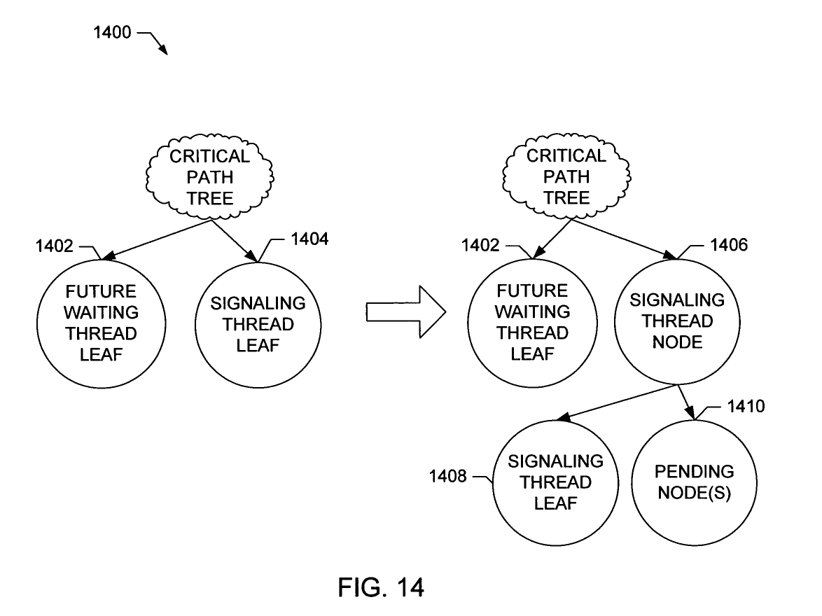

The operation of an example signal event process 1300 is described in conjunction with a critical path possibility tree 1400 as shown in FIG. 14. The critical path possibility tree 1400 includes a future waiting thread leaf 1402 and a signaling thread leaf 1404.

Upon detection of a signal event, the signal event process 1300 determines if there are more than zero threads waiting on the signaled object (block 1302). If there are more than zero threads waiting on the signaled object (block 1302), the signaling thread leaf 1404 is converted into a signaling thread node 1406 (block 1304) and a signaling thread leaf 1408 is created (block 1306). Subsequently, the signal event process 1300 creates nodes for all future waiting threads, one such node is shown in FIG. 14 at reference numeral 1410 as a pending node (block 1308). The pending nodes 1410 are then set as possible leaves for their pending threads (block 1310). In contrast, the pseudocode of FIG. 12 describes an implementation in which only one node is ever created no matter how many threads are waiting. That single node is duplicated later on if several waiting threads wish to use that leaf.

After the signal event process 1300 adds the signaling thread leaf 1408 and the pending nodes 1410 as children from the signaling thread node 1406 (blocks 1304-1310), the resource count of the signaling thread node 1406 is set to the resource count of the signal (block 1312). As will be readily appreciated by those having ordinary skill in the art, the resource count of the signal is indicative of the number of objects being released by the signaling of a thread.

After the resource count is set (block 1312) or if there are no more than zero threads waiting for the object signaled to be released (block 1302), the signal event process 1300 determines if the signal event is a signal and wait-type event (block 1314). If the signal event is not a signal and wait event (block 1314), a signal thread API is called (block 1316), which is a pass to the operating system.

If the signaling thread node 1406 is exiting (block 1318), the thread is marked as dead (block 1320), the concurrency level is decremented (block 1322) and the signal event process 1300 ends or returns control to the critical path generation process 500. Alternatively, if the signal event is a signal and wait event (block 1314), the wait event 510, explained below, will be executed.

Upon control returning from the wait event 510 or if the thread is not exiting (block 1318), the signal event process 1300 determines if the signal failed (block 1324). If the signal failed (block 1324), the tree changes carried out in the signal event process are reversed, or undone (block 1326). After the tree changes are undone (block 1326) or if the signal did not fail (block 1324), the signal event process 1300 ends execution and returns control to the critical path generation process 500.

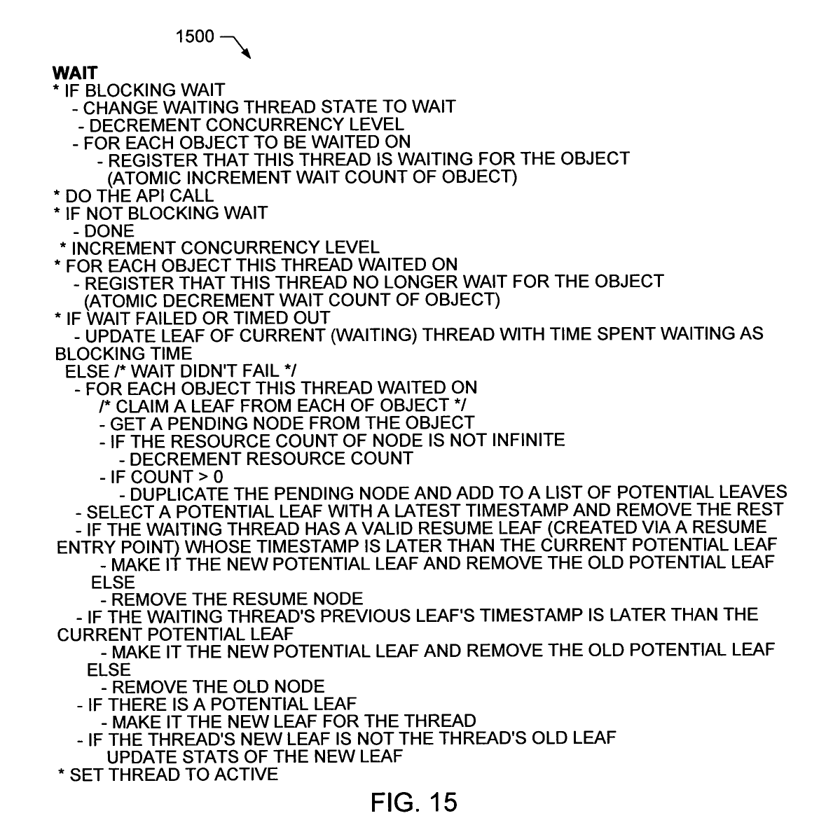

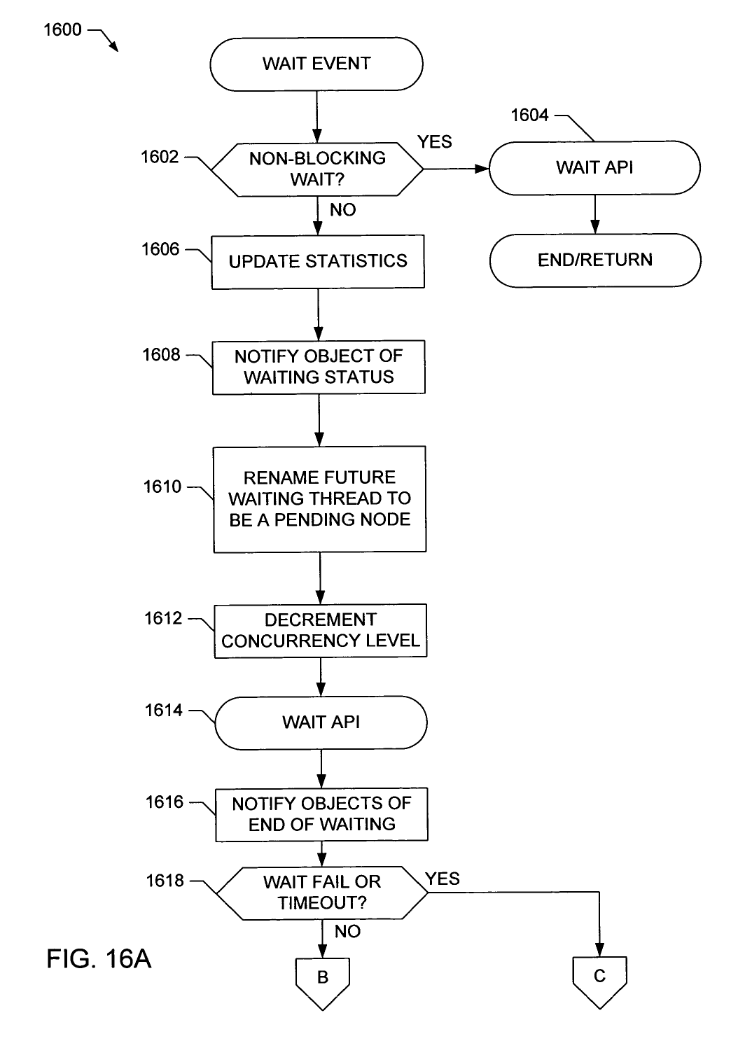

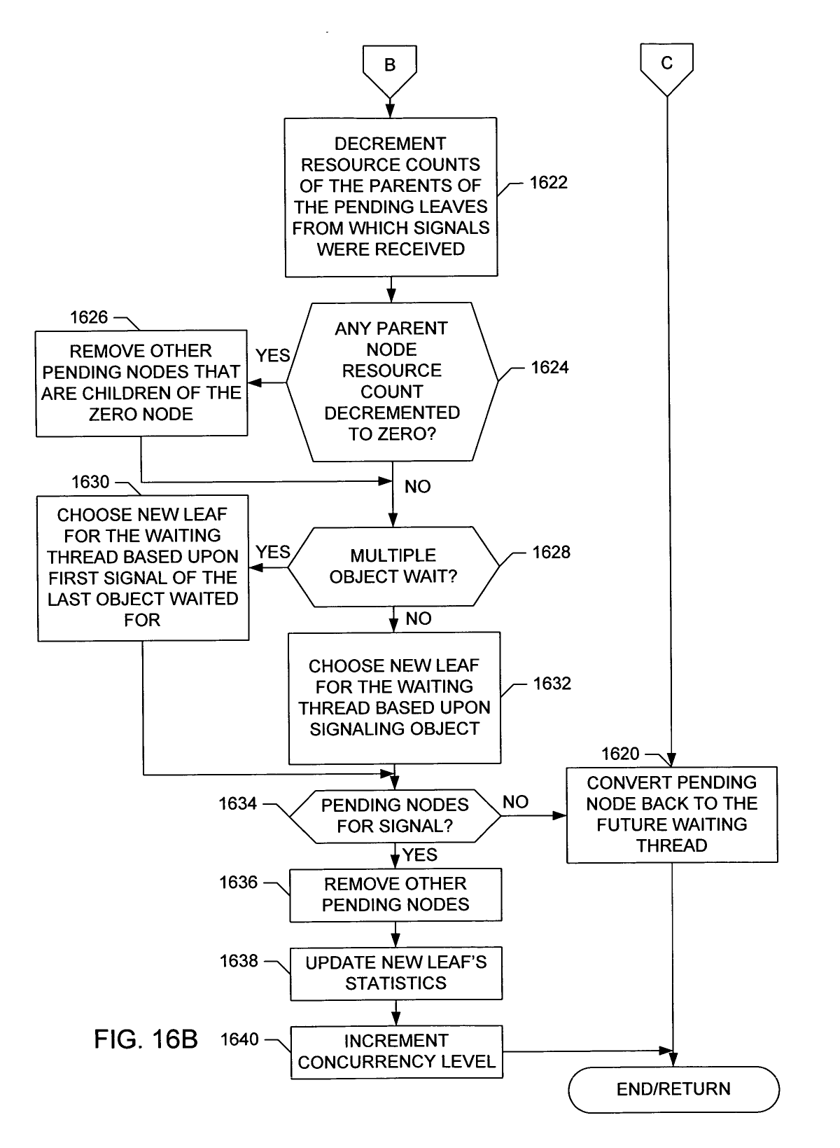

Returning again to FIG. 5, if the cross-thread event is a wait event, the wait event process 510 is initiated. Example wait processes are shown at reference numerals 1500 and 1600 in FIGS. 15 and 16, respectively. As will be readily appreciated by those having ordinary skill in the relevant art, a wait cross-thread event is an event in which a thread has indicated that it is awaiting a particular resource. For example, a wait event occurs when a first thread is waiting for a second thread to release an object. Wait events are related to signal events inasmuch as a waiting thread is waiting to be signaled that the desired resource is being released by another thread. The wait event process 380 covers EnterCriticalSection, WaitForSingleObject, WaitForMultipleObjects and SignalAndWait scenarios.

Referring now to FIG. 15, a pseudocode description 1500 of a wait process is provided. First it is determined if the API to be called will actually cause the thread to wait or block. If not, the OS is called with the API and control is returned back to the user. The current thread's state is set as waiting and the system's concurrency level is decremented. For each object that is being awaited, the process 1500 increments the number of threads that are waiting for that synchronization object.

The actual API is called through the OS and the system's concurrency level is incremented and decremented back down to the waiting thread count for each of the sync objects. If the wait timed out, the current thread's leaf records the time spent waiting as blocking time. Conversely, if the wait succeeded:

For each sync object that signaled use (one if waiting for a single object or one of many, more than one if waiting for all of multiple objects) claim a pending node from that sync object. If the signal count of the pending node is not infinite, decrement the signal count. If the remaining count is greater than 0 then duplicate the pending node.

Select one leaf to use from the leaves collected from the above objects. This is based on the latest signal timestamp. The other pending nodes are removed.

If the waiting thread was resumed and has a valid pending resume leaf (created via the resume code block) whose timestamp is after the potential pending leaf from the above step, then use that instead and remove the unused potential leaf.

If the waiting thread's previous leaf started waiting after the pending leafs signal timestamp, then use that instead as the new potential pending leaf and remove the unused one. Ensure the chosen potential leaf is the new active leaf for the thread. If this was a cross-thread event then update the statistics in the thread's new active leaf and set the current thread's state to active.

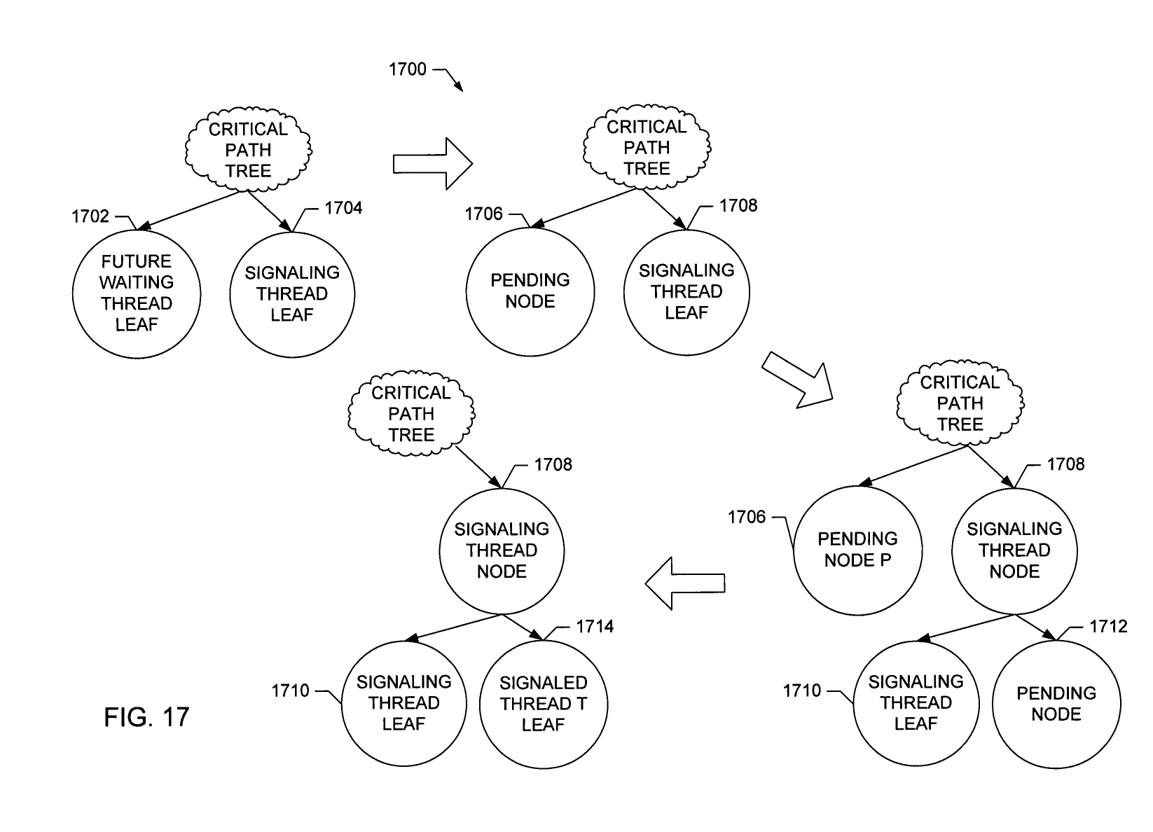

Turning to FIG. 16, after the wait event process 1600 is initiated, the process 1600 determines if the wait is a non-blocking wait (block 1602). If the wait is a non-blocking wait, a wait API 1604 is called and execution of the wait event process 1600 ceases. Alternatively, if the wait is a blocking wait (block 1602), the statistics (the span) of the future waiting thread is updated (block 1606). The object for which a future waiting thread leaf 1702 of FIG. 17 is waiting is informed that the future waiting thread leaf 1702 is, indeed, waiting for that object (block 1608). That is, the future waiting thread leaf 1702 indicates that it is waiting to be signaled when the desired object becomes available. After the desired object is notified of the waiting status of the future waiting thread leaf 1702 (block 1608), the future waiting thread leaf 1702 is renamed to be a pending node 1706 (block 1610) and the concurrency level is decremented (block 1612). After the concurrency level is decremented (block 1612), the wait API 1614 is called, which is an operating system pass.

For illustrative purposes, it is assumed that during the execution of the wait API 1614, the signaling thread leaf 1704 signals (i.e., indicates to the pending node 1706 that the signaling thread leaf 1704 is releasing the resource for which the pending node 1706 is waiting). The act of signaling causes the signaling thread leaf 1704 to convert to a signaling thread node 1708 having children of a signaling thread leaf 1710 and a pending node 1712. For additional details on the signal event process, refer to the previous description thereof. When the pending node 1706 receives the signal from the signaling thread leaf 1710 and accepts the resource being released by the signaling thread leaf 1710, the pending node 1706 is pruned from the critical path tree, and the pending node 1712 is converted to a signaled thread T leaf 1714. In contrast, as described in connection with the wait process pseudocode 1500 of FIG. 15, if the signal count of the pending node was greater than one, the pending node may be duplicated and remain in the tree when a waiting thread claims it.

Returning to the description of FIG. 16, when control returns to the wait event process 1600 from the wait API 1614, the objects desired by the future waiting thread leaf 1702 are notified that the future waiting thread leaf 1702, which, in the interim, has been converted to the pending node 1706, is no longer waiting (block 1616). Control only returns to the wait event process 1600 when the wait API has succeeded, failed or timed out. The wait event process 1600 then determines if the wait API 1614 failed or timed out (block 1618). If the wait API 1614 failed or timed out, the wait event process 1600 converts the pending node 1706 back to the future waiting thread leaf 1702 (block 1620).

Alternatively, if the wait API 1614 did not timeout or fail (block 1618), the wait API must have been successful and, therefore, the resource counts of the parent nodes of pending leaves for which signals were received are decremented (block 1622). After the resource counts are decremented (block 1622), the wait event process 1600 determines if any parent node has been decremented to zero (block 1624). If any parent node is decremented to zero (block 1624), pending nodes of the node decremented to zero are removed (block 1626).

After either the children of the zero resource count node are removed (block 1626) or the wait event process 1600 determines that no parent node resource counts have been decremented to zero (block 1624), the wait event process 1600 determines if the wait taking place is a multiple object wait (block 1628). If the wait is a multiple object wait (block 1628), a new leaf for the critical path tree is selected for the waiting thread based on the first signal of the last object for which the waiting thread is waiting (block 1630). Alternatively, if the wait is not a multiple object wait, a new leaf for the critical path tree is chosen based upon the signaling object (block 1632).

If there are no pending nodes for the signal (block 1634), the pending node is converted back to the future waiting thread leaf (block 1620) before execution of the wait even process terminates. Alternatively, if there are pending nodes for the signal (block 1634), other pending nodes for the signal are removed (block 1636) and the span of the new leaf is updated (block 1638). The concurrency level is then incremented 1640 and the execution of the wait event process 1600 terminates.

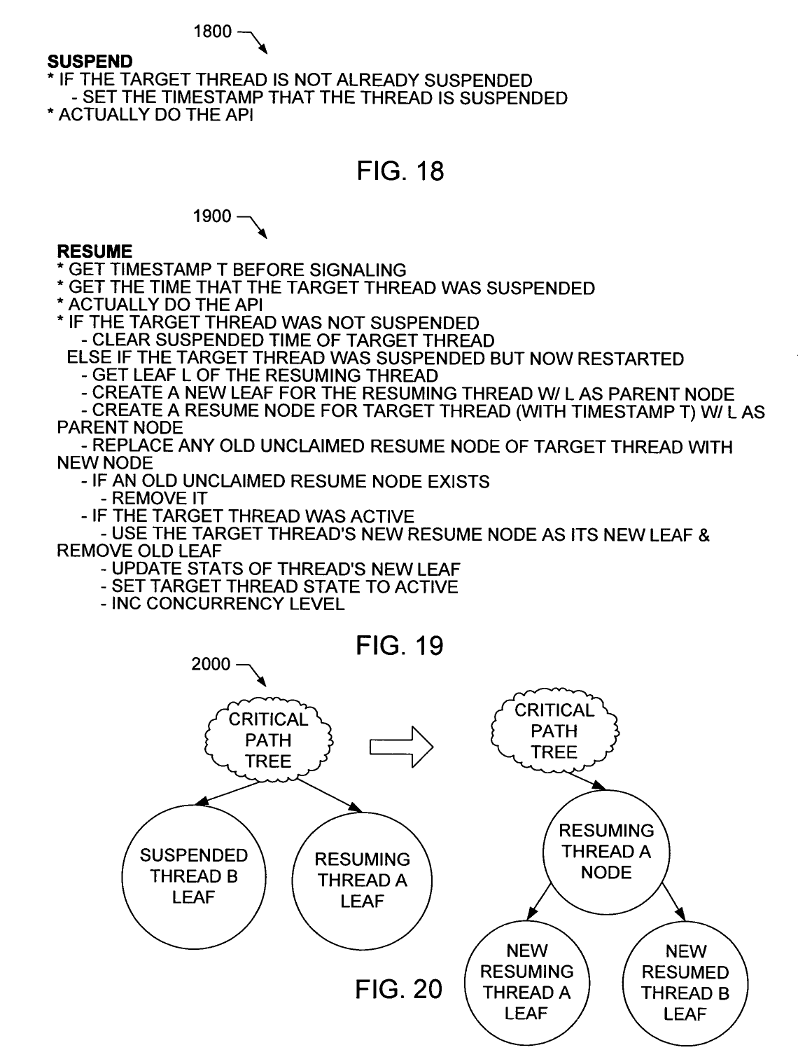

Returning to FIG. 5, if the cross-thread event is a suspend event 512, instructions represented by the pseudocode of a suspend event 1800 of FIG. 18 are executed. The suspend event 1800 determines if the target thread (i.e., the thread to be suspended) is already suspended. If the target thread is not already suspended, the timestamp of the thread that is suspended is set. After either the timestamp is set or it is determined that the target thread is already suspended, the API is executed.

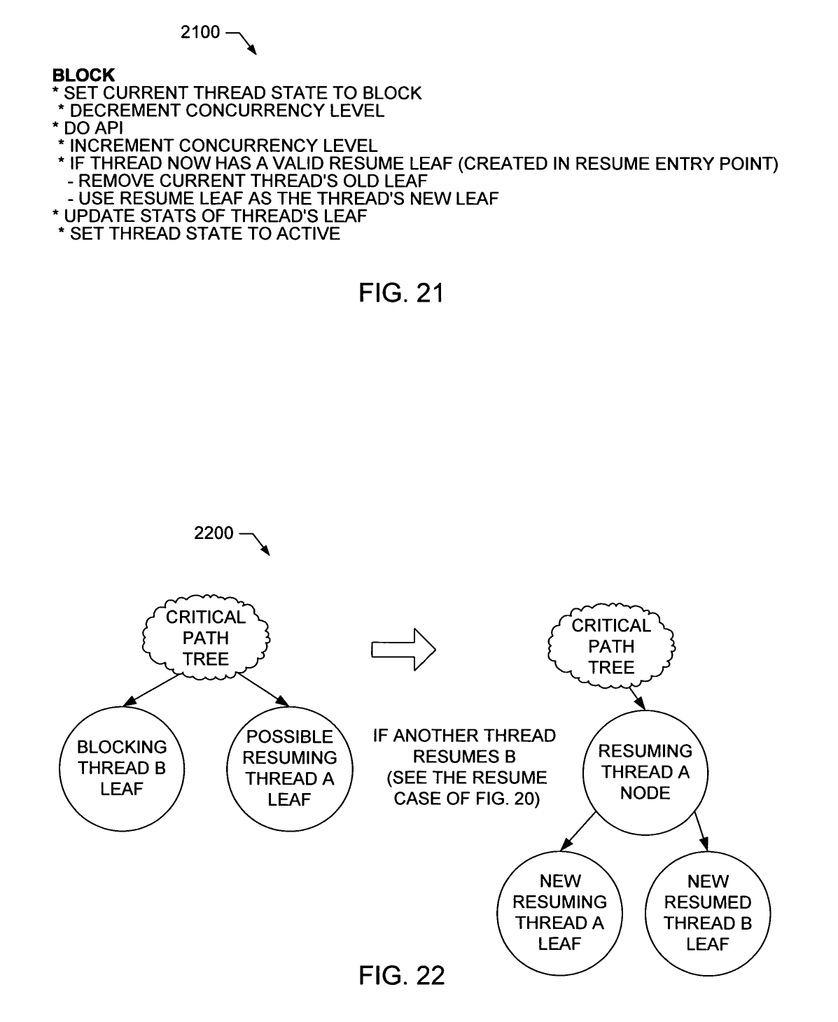

If, with reference to FIG. 5, the cross-thread event is a resume event 514, a resume event process 1900 as represented by the pseudocode of FIG. 19 is carried out. The resume event process 1900 is described in conjunction with the critical path tree 2000 of FIG. 20. The resume code block operates as follows:

First, the current timestamp and the time the target thread was first suspended are obtained. Then the OS is called to perform the resume API. If the target thread was not actually suspended, it is ensured that the target thread's data structure indicates it is not suspended and control is returned to the user. If the target thread was actually resumed, however, the following is performed:

Obtain the leaf of the current (resuming) thread.

Create a new leaf for the target thread with the current thread's leaf as its parent.

Install this new pending leaf as the pending resume leaf in the target thread structure. If an unclaimed pending resume leaf already exists for the target thread, remove it.

If the target thread was active then use this new pending resume leaf as the thread's new active leaf, update its statistics, set the target thread's state to active, and increase the system's concurrency level.

In the alternative, if the cross-thread event detected by the process of FIG. 5 is a block event, a block event process 2100 is carried out. An example block event process 2100 is represented by pseudocode in FIG. 21 and described in conjunction with the critical path tree 2200 of FIG. 22. Referring to FIG. 21, the block event process 2100 sets the current state of the thread to block and decrements the system concurrency level. The OS is then called to perform the requested API. Afterward, the system concurrency level is re-incremented. If the thread was resumed in the interim (has a pending resume leaf), then this leaf is used as the new active leaf. In the alternative, the system continues to use the existing active leaf. The statistics of the active leaf of the current thread are updated and the state of the current thread is set back to the active state.

Although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1. A method of profiling a threaded program during program runtime, the method comprising:
monitoring information exchanged between a processing unit and first and second threads executed by the processing unit;
determining, based on the information exchanged between the processing unit and the first and second threads, a critical path of thread execution and maintaining the critical path of thread execution in a critical path tree;
determining, based on the information exchanged between the processing unit and the first and second threads, a wait time during which the first thread awaits a synchronization event; and
determining whether the wait time affects the critical path of thread execution.

2. A method as defined by claim 1, further comprising indicating that the wait time is of a high priority if the wait time affects the critical path of thread execution and indicating that the wait time is of a low priority if the wait time does not affect the critical path of thread execution.

3. A method as defined by claim 1, wherein a leaf is added to the critical path tree when the synchronization event is a fork event.

4. A method as defined by claim 1, wherein a leaf is added to the critical path tree when the synchronization event is a signal event.

5. A method as defined by claim 1, wherein a leaf is removed from the critical path tree when the synchronization event is a wait event.

6. A method as defined by claim 1, wherein a leaf is added to the critical path tree when the synchronization event is an entry event.

7. A method as defined by claim 1, wherein a leaf is removed from the critical path tree when the synchronization event is a block event.

8. A method as defined by claim 1, wherein a leaf is removed from the critical path tree when the synchronization event is a suspend event.

9. A method as defined by claim 1, wherein a leaf is added to the critical path tree when the synchronization event is a resume event.

10. A method as defined by claim 1, further comprising comparing a number of active threads to a number of processing resources to determine a utilization factor.

11. An article of manufacture comprising a machine-accessible medium having a plurality of machine-accessible instructions that, when executed, causes a machine to:
monitor information exchanged between a processing unit and first and second threads executed by the processing unit;
determine, based on the information exchanged between the processing unit and the first and second threads, a critical path of thread execution and maintaining the critical path of thread execution in a critical path tree;
determine, based on the information exchanged between the processing unit and the first and second threads, a wait time during which the first thread awaits a synchronization event; and
determine whether the wait time affects the critical path of thread execution.

12. A machine-accessible medium as defined by claim 11, wherein the plurality of machine-accessible instructions, when executed, causes a machine to indicate that the wait time is of a high priority if the wait time affects the critical path of thread execution and indicating that the wait time is of a low priority if the wait time does not affect the critical path of thread execution.

13. A machine-accessible medium as defined by claim 12, wherein the plurality of machine-accessible instructions, when executed, causes a machine to add a leaf to the critical path tree when the synchronization event is a fork event.

14. A machine-accessible medium as defined by claim 12, wherein the plurality of machine-accessible instructions, when executed, causes a machine to add a leaf to the critical path tree when the synchronization event is a signal event.

15. A machine-accessible medium as defined by claim 12, wherein the plurality of machine-accessible instructions, when executed, causes a machine to remove a leaf from the critical path tree when the synchronization event is a wait event.

16. A machine-accessible medium as defined by claim 12, wherein the plurality of machine-accessible instructions, when executed, causes a machine to add a leaf to the critical path tree when the synchronization event is an entry event.

17. A machine-accessible medium as defined by claim 12, wherein the plurality of machine-accessible instructions, when executed, causes a machine to remove a leaf from the critical path tree when the synchronization event is a block event.

18. A machine-accessible medium as defined by claim 12, wherein the plurality of machine-accessible instructions, when executed, causes a machine to remove a leaf from the critical path tree when the synchronization event is a suspend event.

19. A machine-accessible medium as defined by claim 12, wherein the plurality of machine-accessible instructions, when executed, causes a machine to add a leaf to the critical path tree when the synchronization event is a resume event.

20. A machine-accessible medium as defined by claim 12, wherein the plurality of machine-accessible instructions, when executed, causes a machine to compare a number of active threads to a number of processing resources to determine a utilization factor.

21. A method of profiling a threaded program during program runtime, the method comprising:
monitoring information exchanged between a processing unit and first and second threads executed by the processing unit;
determining when a cross-thread event has occurred;
determining, based on the cross-thread event, a critical path of thread execution and maintaining the critical path of thread execution in a critical path tree;
determining, based on the cross-thread event and the information exchanged between the processing unit and the first and second threads, a wait time during which the first thread awaits a synchronization event; and
determining whether the wait time affects the critical path of thread execution.

22. A method as defined by claim 21, further comprising indicating that the wait time is of a high priority if the wait time affects the critical path of thread execution and indicating that the wait time is of a low priority if the wait time does not affect the critical path of thread execution.

23. A method as defined by claim 22, wherein the cross-thread event is selected from a group consisting of a fork event, an entry event, a signal event, a wait event, a suspend event, a resume event, and a block event.

24. A method as defined by claim 22, wherein a leaf is added to the critical path tree when the synchronization event is a fork event.

25. A method as defined by claim 22, wherein a leaf is added to the critical path tree when the synchronization event is a signal event.

26. A method as defined by claim 22, wherein a leaf is removed from the critical path tree when the synchronization event is a wait event.

27. A method as defined by claim 22, wherein a leaf is added to the critical path tree when the synchronization event is an entry event.

28. A method as defined by claim 22, wherein a leaf is removed from the critical path tree when the synchronization event is a block event.

29. A method as defined by claim 22, wherein a leaf is removed from the critical path tree when the synchronization event is a suspend event.

30. A method as defined by claim 22, wherein a leaf is added to the critical path tree when the synchronization event is a resume event.

31. A method as defined by claim 22, further comprising comparing a number of active threads to a number of processing resources to determine a utilization factor.

32. An article of manufacture comprising a machine-accessible medium having a plurality of machine-accessible instructions, when executed, causes a machine to:
monitor information exchanged between a processing unit and first and second threads executed by the processing unit;
determine when a cross-thread event has occurred;
determine, based on the cross-thread event, a critical path of thread execution and maintaining the critical path of thread execution in a critical path tree;
determine, based on the cross-thread event and the information exchanged between the processing unit and the first and second threads, a wait time during which the first thread awaits a synchronization event; and
determine whether the wait time affects the critical path of thread execution.

33. A machine-accessible medium as defined by claim 32, wherein the plurality of machine-accessible instructions, when executed, causes a machine to indicate that the wait time is of a high priority if the wait time affects the critical path of thread execution and indicating that the wait time is of a low priority if the wait time does not affect the critical path of thread execution.

34. A machine-accessible medium as defined by claim 32, wherein the plurality of machine-accessible instructions, when executed, causes a machine to add a leaf to the critical path tree when the synchronization event is a fork event.

35. A machine-accessible medium as defined by claim 32, wherein the plurality of machine-accessible instructions, when executed, causes a machine to add a leaf to the critical path tree when the synchronization event is a signal event.

36. A machine-accessible medium as defined by claim 32, wherein the plurality of machine-accessible instructions, when executed, causes a machine to remove a leaf from the critical path tree when the synchronization event is a wait event.

37. A machine-accessible medium as defined by claim 32, wherein the plurality of machine-accessible instructions, when executed, causes a machine to add a leaf to the critical path tree when the synchronization event is an entry event.

38. A machine-accessible medium as defined by claim 32, wherein the plurality of machine-accessible instructions, when executed, causes a machine to remove a leaf from the critical path tree when the synchronization event is a block event.

39. A machine-accessible medium as defined by claim 32, wherein the plurality of machine-accessible instructions, when executed, causes a machine to remove a leaf from the critical path tree when the synchronization event is a suspend event.

40. A machine-accessible medium as defined by claim 32, wherein the plurality of machine-accessible instructions, when executed, causes a machine to add a leaf to the critical path tree when the synchronization event is a resume event.

41. A machine-accessible medium as defined by claim 32, wherein the plurality of machine-accessible instructions, when executed, causes a machine to compare a number of active threads to a number of processing resources to determine a utilization factor.
